(19) United States
(12) Patent Application Publication
(10) Pub. No.: US 2018/0178634 A1
(43) Pub. Date: Jun. 28, 2018

(54) SHADING DEVICE FOR A MOTOR VEHICLE WINDOW

(71) Applicant: BOS GMBH & CO. KG, Ostfildern (DE)

(72) Inventor: Roman SAUER, Grossbettlingen (DE)

(21) Appl. No.: 15/736,012

(22) PCT Filed: Jun. 14, 2016
(86) PCT No.: PCT/EP2016/063617

§ 371 Date: Dec. 13, 2017

(30) Foreign Application Priority Data
Jun. 19, 2015 (DE) 10 2015 007 777.5

(51) Int. Cl. B60J 1/20

(52) U.S. Cl. CPC B60J 1/2033; B60J 1/2063; B60J 1/2052

(57) ABSTRACT

A shading structure for a motor vehicle windshield including a profiled pull-out section attached to the shading structure at an end face and which is moved between a lowered rest position and an extended functional position in lateral guiding rails fixed to the vehicle by a drive transmission means. In the rest position, the shading structure is lowered into a shaft fixed to the vehicle through a passage. The passage is closed by a lid which is pivoted between open and a closed positions, and a control mechanism is provided for opening and closing the lid. The control mechanism is coupled to a displacement movement of the pull-out section. The control mechanism has a traction mechanism that controls the lid between the open position and an intermediate position located between the open position and the closed position of the lid, on the basis of the pull-out section passing through the passage.

The invention relates to a shading device for a motor vehicle window, having a shading structure with an extension profile attached to the end side of the shading structure, said extension profile being displaceable in lateral guide rails secured to the vehicle between a lowered rest position and an extended functional position with the aid of drive transmission means, wherein, in the rest position, the shading structure has been lowered through a passage into a compartment secured to the vehicle, wherein the passage is closable by a cover that is pivotable between an open and a closed position, and wherein a control mechanism for opening and closing the cover is provided, said control mechanism being coupled with a displacement movement of the extension profile.

A shading device of this type is known from laid-open specification DE 10 2008 045 053 A1. The known shading device has a roller-blind box connected to a door or a vehicle body, said roller-blind box being closable with a pivotable cover. Mounted in a rotatable manner in the roller-blind box is a winding shaft on which a roller-blind web is able to be wound. Fastened to the end side of the roller-blind web is a pull bar which acts on a compression spring in a closed position of the cover. If the pull bar is lifted out of its closed position by means of a pulling cable, the compression spring, which is pretensioned with the cover closed, pushes the cover into its open position. If the roller-blind web is wound onto the roller-blind shaft, in an end phase of the winding-on process, the pull bar comes into contact with the compression spring such that the compression spring is tensioned and the cover is closed.

Laid-open specification DE 10 2012 200 259 A1 discloses a covering system for a motor vehicle window, having a covering that is displaceable between a stowed position and a covering position. The covering has an extension rod which is connected to sliding elements that are displaceable in guide rails. A base of the covering system has a receiving space for the covering, with an outlet gap. The outlet gap is closable with a cover unit. Arranged between the base and the cover unit are leg springs which apply a constant turning moment to the cover unit in the opening direction. If the covering is moved into the stowed position, on approaching an end position, one of the sliding elements of the extension rod acts on a sliding element connected to the cover unit, said sliding element introducing a closing moment into the cover unit, said closing moment being greater than the turning moment of the leg springs in the opening direction, and the cover is closed.

The object of the invention is to create a shading device of the type mentioned at the beginning, which has a visually appealing appearance in a rest position and a functional position of the shading structure.

This object is achieved in that the control mechanism has a traction mechanism drive which, depending on whether the extension profile has passed through the passage, controls the cover between the open position and an intermediate position which is located between the open position and closed position of the cover. In particular in a fully extended position of the extension profile, the cover takes up the intermediate position in which it can rest on the shading structure with slight pressure or without contact. Advantageously, the cover largely covers the passage in the process, such that no contaminants such as dust, for example, can pass through the passage. In an intermediate position, the cover has been moved closer to the shading structure, such that the cover projects less far up into a field of view of the vehicle window than in the open position. This results in a visually appealing appearance. In addition, injuries in the event of a vehicle collision can be reduced as a result of the cover projecting less far up.

In one configuration of the invention, the traction mechanism drive is embodied at least partially in a spring-elastic manner. This advantageously produces overload protection and also the risk of injury by crushing of body parts is minimized. A spring-elastic function can be provided at one or more functional points of the traction mechanism drive.

In a further configuration, the traction mechanism drive comprises an elastic cord or at least one spring-elastic element. The elastic cord can be rubber-elastic or have a rubber-elastic portion. Alternatively, a nonelastic cord can have a spring-elastic portion such as a helical tension spring. Advantageously, this thus results in a wide variety of dimensioning and adaptation possibilities, such that the traction mechanism drive can be designed in accordance with the available installation space.

In a further configuration of the invention, the traction mechanism drive extends between a driver, arranged in the region of at least one lateral guide rail, and a region of action rotationally fixed to the cover. This results in an operative connection between the guide rail, the driver and the cover. Advantageously, a displacement of the cover with relatively few components can thus be brought about. In this case, both an opening and a closing moment can be introduced into the region of action. The opening and closing moments can alternatively also be introduced into different regions of the cover. The region(s) of action can be provided directly on the cover or be separate components connected to the cover.

In a further configuration of the invention, the traction mechanism drive has a deflector which converts a direction of movement of the driver, when the extension profile is transferred from the rest position into the functional position, into a closing movement of the cover. The deflector can be stationary or be coupled to the extension movement of the extension profile and thus be displaceable approximately in a direction of movement of the extension profile. When a displaceable deflector is used, in particular in the form of a deflection roller mounted in an elastically resilient manner, a nonelastic traction mechanism drive can alternatively be provided.

In a further configuration of the invention, the control mechanism comprises a control pushrod that acts on the cover in order to transfer the cover into a closed position or an open position depending on the position of the extension profile. The control pushrod can act both in the opening and in the closing direction of the cover, depending on an extension-profile position. In the event of a displacement of the extension profile into the rest position of the shading structure, the control pushrod can act on the cover with a tractive force and transfer the latter into a closed position. In the event of a displacement of the extension profile into the functional position of the shading structure, the control pushrod can act on the cover with a compressive force and displace the latter into an open position. Thus, opening and closing of the cover can advantageously be effected with relatively few components.

In a further configuration of the invention, a closing moment, introduced into the cover, of the traction mechanism drive is greater than the opening moment of the control pushrod. Upon activation of the traction mechanism drive, a control-pushrod spring is pretensioned, the cover is displaced into the intermediate position and held there, while the shading structure is extended.

Further advantages and features of the invention can be gathered from the claims and the following description of preferred exemplary embodiments of the invention, which are illustrated in the drawings.

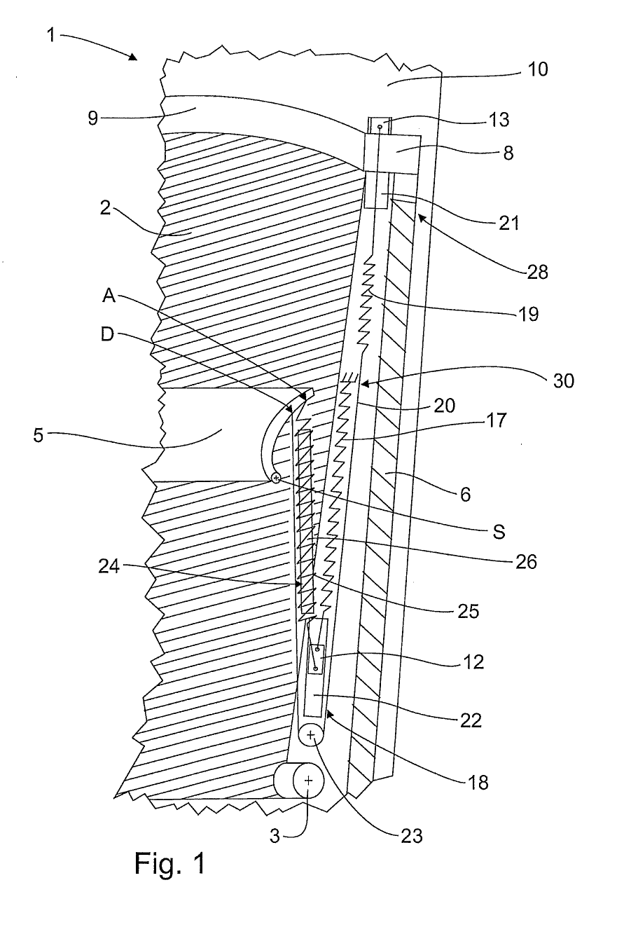

FIG. 1 shows a side region of one embodiment of the shading device according to the invention for shading a motor vehicle window,

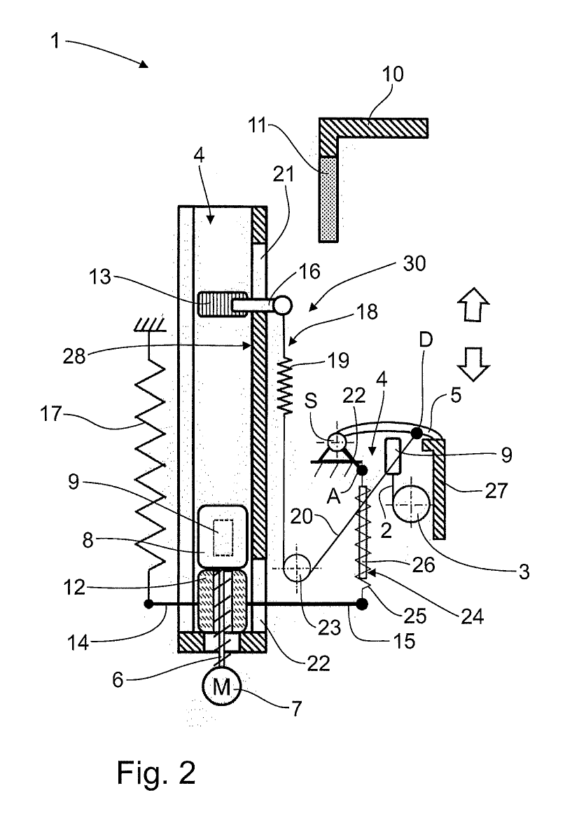

FIG. 2 shows a sectional illustration of a further embodiment of the shading device according to the invention in a rest position of the shading structure with a closed cover,

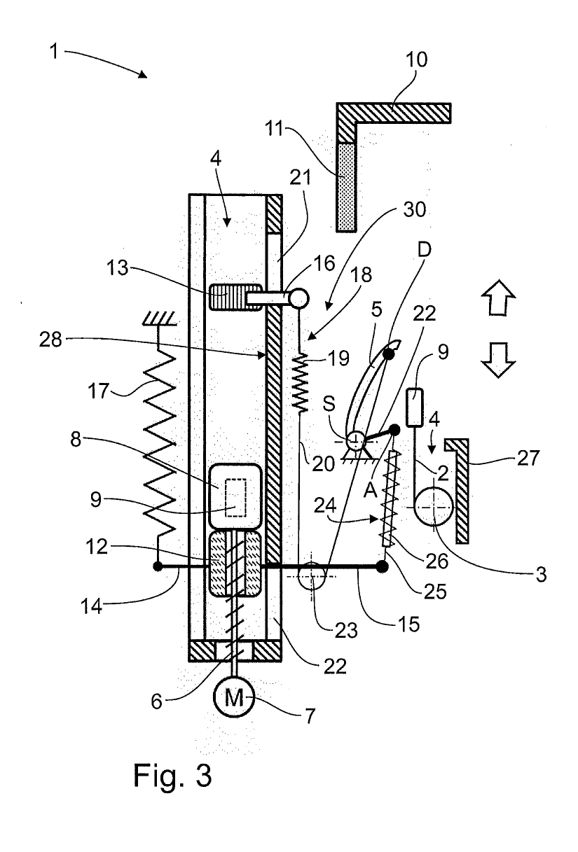

FIG. 3 shows the shading device from FIG. 2 with the cover open at the beginning of a displacement movement of an extension profile,

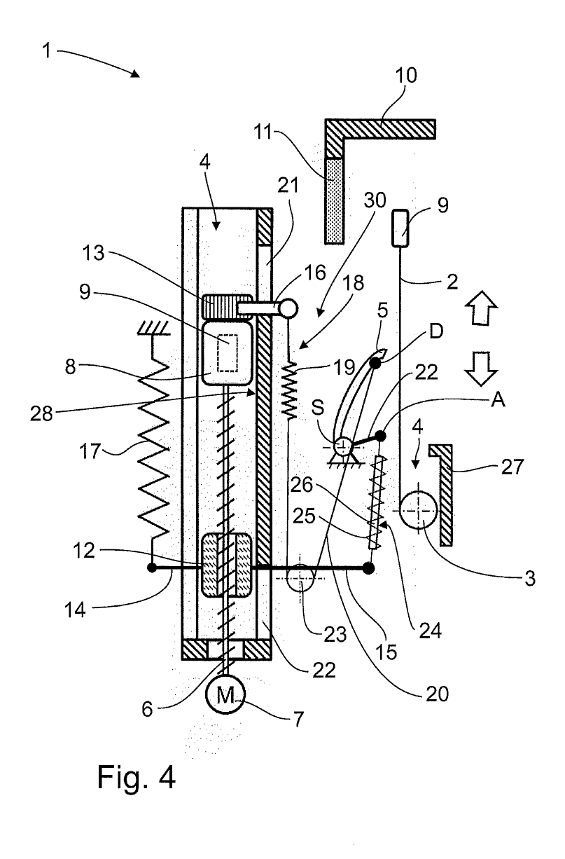

FIG. 4 shows the shading device from FIG. 3 with the cover open toward the end of the displacement movement of the extension profile, and

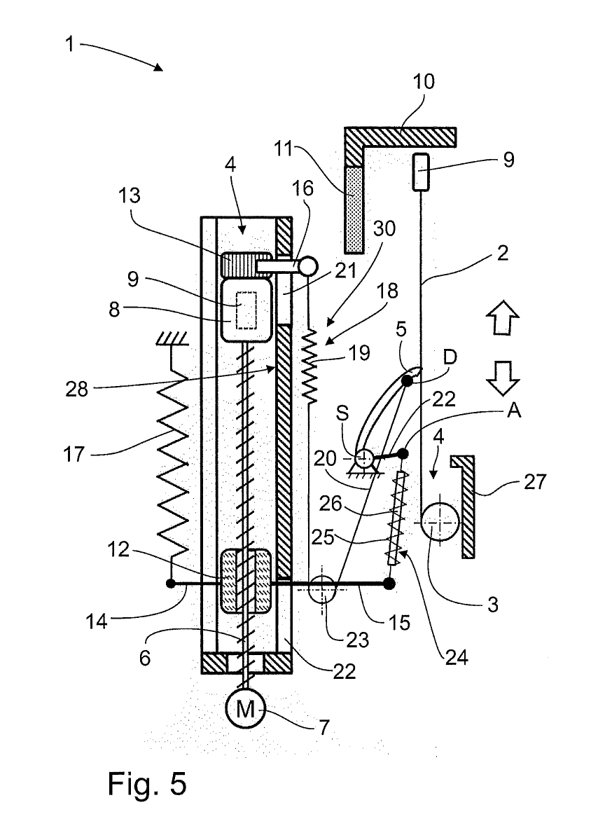

FIG. 5 shows the shading device from FIG. 4 when an extended functional position of the extension profile has been reached, with the cover in an intermediate position.

A shading device 1 for a motor vehicle window 11 of a rear side door according to FIGS. 1 to 5 is provided for use in a passenger car. The shading device 1 comprises a shading structure 2 which is designed as a flexible sheet-like structure and can consist for example of a textile or plastics web. The shading structure 2 fulfills the purpose of avoiding excessive light penetration into a vehicle interior and accordingly has low light permeability. The shading structure 2 is connected in a conventional manner at its end sides to a winding shaft 3 on which the shading structure 2 is able to be rolled and unrolled. On a side of the shading structure 2 that is remote from the winding shaft 3, the shading structure 2 has an extension profile 9. In its side regions, the extension profile 9 has drivers 8 which are displaceable in guide rails 28. The guide rails 28 are arranged, in side regions of the rear side door, on two opposite sides of the motor vehicle window 11 to be shaded and extend in a vertical direction as far as a door pillar 10.

The shading structure 2 and the rotatably mounted winding shaft 3 are arranged in a vehicle-side compartment 4 and, in an operationally mounted state of the shading device 1, are concealed by door interior trim 27. Also arranged on the vehicle side are a drive 7 and two drive transmission means 6. The position of the drive 7 can be selected depending on available installation space; the drive transmission means 6 flank the motor vehicle window 11 in its two side regions.

The drive 7 comprises an electric motor with a gear wheel output. The drive transmission means 6 have flexible thread pitch cables driven by the gear wheel output. A rotation of the electric motor and of the gear wheel output connected thereto is converted into a movement of the drive transmission means 6 in translation. The drive transmission means 6 extend parallel to the guide rails 28 in the side regions of the motor vehicle window 11 and are connected to the extension profile 9 via drivers 8. One driver 8 per side region is provided in each case, in order to ensure synchronous displacement of the shading structure 2.

For reasons of clarity, only in each case one side region of the rear side door is illustrated in FIGS. 1 to 5. Alternatively, it is also possible for a drive cable such as a Bowden cable or a flexible pulling cable, for example, to be used as drive transmission means 6.

FIG. 1 illustrates a detail of a rear side door. The motor vehicle window 11 is concealed by the shading structure 2 and thus not discernible. The door interior trim 27 and the compartment 4 are not illustrated here for reasons of greater clarity. The extension profile 9 is in a fully extended functional position and ends at a door pillar 10.

In the side region illustrated, the compartment 4 has the guide rail 28, in which a lower entraining element 12 and an upper entraining element 13, which are slidable slot nuts in the exemplary embodiment illustrated, are vertically displaceable. The drive transmission means 6 is connected to the driver 8, which in turn is connected to the extension profile 9. The extension profile 9 is displaceable in a guided manner in the guide rail 28 by means of the driver 8.

In a region, facing the motor vehicle window 11, of a door breastwork, a passage is arranged in the compartment 4, in which the winding shaft 3 is accommodated. The passage extends along an entire longitudinal extent of the motor vehicle window and is designed such that the extension profile 9 and the shading structure 2 can pass through it. The passage is closable by a longitudinally extending, pivotably mounted cover 5. A pivot pin of the cover 5 is arranged in a manner fixed to the door. In its closed position, the cover 5 completely covers the passage of the compartment 4.

Provided in a side region of the cover 5 is a control pushrod 24 which comprises a control pushrod spring 25 and a control pushrod body 26. The control pushrod 24 acts on a lever 29 of the cover 5 at a point of action A and acts thereon both in a pushing direction and in a pulling direction in order to displace the cover 5 into a completely open or completely closed position.

The lower entraining element 12 has, in the exemplary embodiment illustrated in FIGS. 2 to 5, two horizontally projecting arms 14, 15. Fastened to the first arm 14 is a tension spring 17 which is connected to a vehicle structure on a side remote from the first arm 14. Arranged on that side of the lower entraining element 12 that is remote from the first arm 14, is the second arm 15. The control pushrod 24 acts on the latter. On that side of the control pushrod 24 that is remote from the second arm 15, said control pushrod 24 is connected to the point of action A of the lever 29. The second arm 15 is displaceable in a guided manner along a vertically extending delimiting slot 22.

The delimiting slots 21, 22 define a maximum displacement travel of the entraining elements 12, 13. In FIGS. 2 to 5, the arms 15, 16 are displaceable in a guided manner in the delimiting slots 21, 22. In FIG. 1, the entraining elements 12, 13 are illustrated as slot nuts which are displaceable in a slidable manner in the delimiting slots 21, 22.

The lower entraining element 12 has a vertical through-opening. This through-opening is penetrated by the drive transmission means 6, which is connected in its upper region to the driver 8 and in its lower region to the drive 7.

In order to pivot the cover 5, a control mechanism 30 is provided, which comprises the control pushrod 24 and a traction mechanism drive 18. The control pushrod 24 serves to displace the cover 5 into the completely open position upon displacement of the shading structure 2 in the direction of the door pillar and to completely close the cover 5 following the displacement of the shading structure 2 into its rest position. In the completely open position of the cover 5, the extension profile 9, which is thicker than the shading structure 2, can be guided through the passage.

The traction mechanism drive 18 of the control mechanism comprises the lower entraining element 12, the upper entraining element 13, a spring-elastic element 19, a cable portion 20, a deflector 23 in the form of a deflection roller, the tension spring 17, and the control pushrod 24.

The shading device 1 according to the invention can have the control mechanism 30 for displacing the cover 5 in a mirror-inverted manner in its two side regions. Alternatively, the cover 5 can be mounted in a pivotable manner on one side and have a control mechanism 30 on an opposite side.

FIGS. 2 to 5 each show, on a left-hand side in the plane of view thereof, the guide rail 28 for displacing the extension profile 9 by means of the drive transmission means 6. Also visible on the left-hand side are the lower and the upper entraining element 12, 13 and the tension spring 17 of the control mechanism 30. Illustrated on the right-hand side of each of FIGS. 2 to 5 are the door interior trim 27, the compartment 4 with the cover 5 mounted so as to be pivotable about a pivot axis S, the spring-elastic element 19, and the control pushrod 24, the deflector 23 and the winding shaft 3. Also visible on the right-hand side in the plane of view is the shading structure 2, unwindable from the winding shaft 3, with the extension profile 9.

According to FIGS. 2 to 5, the shading device 1 is illustrated in a rest position of the shading structure 2. The shading structure 2 is in this case wound up on the winding shaft 3, the extension profile 9 is in a state lowered completely into the compartment 4, and the cover 5 is completely closed. The lower entraining element 12 is in its lower position, in which the tension spring 17 fastened thereto is pretensioned via the first arm 14. In this case, the control pushrod spring 25 is pretensioned via the second arm 15. The control pushrod spring 25 acts on the point of action A of the lever 29 and keeps the cover 5 closed. The spring-elastic element 19 of the traction mechanism drive 18, which is connected to a cover point of action D, is not pretensioned in this position of the cover 5. The tension spring 17, which is connected at one end to the arm 14 and at the other end to a body structure, is spring-elastically pretensioned in the rest position of the shading structure 2.

The control pushrod 24 and the traction mechanism drive 18 can alternatively also act in only one region of the cover 5. The lower entraining element 12 can alternatively have bores according to FIG. 1, by means of which it is connected to the control pushrod 24 and the tension spring 17, wherein the entraining elements 12, 13 do not have arms in this embodiment according to FIG. 1, but rather the control pushrod spring 24 and the tension spring 17 are mounted by way of spring eyes in the bores in the lower entraining element 12. Likewise, instead of an arm 16, the upper entraining element 13 can, according to FIG. 1, have a bore, at which the traction mechanism drive 18 is mounted by way of a spring eye or the like.

The spring-elastic element 19 acts at the point of action A, said spring-elastic element 19 being illustrated schematically in the depicted exemplary embodiment by a helical spring which is integrated into corresponding cable portions and to which the cable portion 20 is attached. According to FIGS. 2 to 5, the spring-elastic element 19 is connected, on its side remote from the cover 5, to an upper arm 16, which projects horizontally from the upper entraining element 13 and is displaceable in a guided manner in a vertically extending upper delimiting slot 21, as has already been explained.

In order to displace the shading structure 2 from its rest position into its functional position, the drive 7 is energized. In the process, the drive transmission means 6 is displaced upward along the guide rail 28 in a plane of view in FIG. 3. The hitherto pretensioned tension spring 17 is now relieved of load and acts on the first arm 14 of the lower entraining element 12, which is consequently displaced upward along the guide rail 28 in the direction of the door pillar 10. The second arm 15, likewise fastened to the lower entraining element 12, is displaced upward along the lower delimiting slot until an upper end of the delimiting slot 22 has been reached, said upper end serving as an end stop for the lower entraining element 12. The control pushrod spring 25, which is fastened to the second arm 15, is relaxed in the process, until it has been compressed to such an extent that it acts as a pushrod. A compressive force is now introduced into the lever 29 by the control pushrod 24, said force opening the cover 5. The control pushrod body 26 of the control pushrod 24 serves in this case as a stabilizer, which prevents the control pushrod spring 25 from buckling laterally under compressive load.

During the displacement of the shading structure 2 into its functional position, the cover 5 remains open according to FIGS. 3 and 4, provided that the extension profile 9 does not act on the upper entraining element 13 and the latter does not act on the traction mechanism drive 18.

In order to displace the cover 5 from its completely open position into an intermediate position, in which the cover 5 rests on the extended shading structure 2 with slight pressure or almost without contact, the extension profile 9 is operatively connected to a traction mechanism drive 18, which can act on the cover 5 at a cover point of action D in the closing direction of the cover 5.

When the shading structure 2 approaches its functional position completely unwound from the winding shaft 3, the upper entraining element 13, which, in the exemplary embodiments, is a slot nut that projects into the movement path of the driver 8, is entrained by the driver 8 that is displaceable with the extension profile 9. The arm 16 attached to the upper entraining element 13 is displaced along the upper delimiting slot 21. In the process, the spring-elastic element 19 of the traction mechanism drive 18 is tensioned. The cable portion 20 connected to the spring-elastic element 19 is deflected via the rotatable deflector 23 and introduces a tractive force into the cover 5 via the cover point of action D, said force resulting in the displacement of the cover 5 into the intermediate position.

The deflector 23 can alternatively be coupled to the guide element 8 in terms of motion so as to move in the opposite direction thereto, such that, when the extension profile 9 is displaced into the functional position, i.e. upward in the direction of the door pillar 10, the deflector 23 is displaced downward and a tractive force is introduced into the traction mechanism drive 18, said force resulting in the cover 5 being displaced into the intermediate position.

The deflector 23 is in this case illustrated as a rotatable deflection roller, but can also alternatively be for example a stationary deflection fork or a deflection pin. In an embodiment that is not illustrated, the spring-elastic configuration of the traction mechanism drive 18 can be realized by spring-elastically resilient attachment regions on the upper entraining element 13 and on the cover 5.

A tractive force of the spring-elastic element 19 exceeds a tractive force of the tension spring 17. Upon force introduction into the cover 5 in the closing direction of the cover 5 by the traction mechanism drive 18, the control pushrod spring 25 is compressed. The spring pushrod is furthermore pushed downward, i.e. in the direction of the winding shaft 3. The spring pushrod 24 displaces the lower entraining element 12 in the lower delimiting slot 22 downward and the tension spring 17 connected to the entraining element 12 is tensioned.

A spring force of the spring-elastic element 19 and a length of the cable portion 20 are structurally dimensioned such that they do not result in the cover 5 being completely closed, but rather displace the cover 5 into the intermediate position, in which the cover 5 takes up a position close to the shading structure 2 without being in contact therewith or rests slightly on the shading structure 2.

1. A shading device for a motor vehicle window, having a shading structure with an extension profile attached to the end side of the shading structure, said extension profile being displaceable in lateral guide rails secured to the vehicle between a lowered rest position and an extended shading position with the aid of drive transmission means, wherein, in the rest position, the shading structure has been lowered through a passage into a compartment secured to the vehicle, wherein the passage is closable by a cover that is movable between an open and a closed position, and wherein a control mechanism for opening and closing the cover is provided, said control mechanism being coupled with a displacement movement of the extension profile, wherein the control mechanism has a traction mechanism drive which, depending on whether the extension profile has passed through the passage, controls the cover between an open position and an intermediate position which is located between the open position and closed position of the cover.

2. The shading device as claimed in claim 1, wherein the traction mechanism drive is embodied at least partially in a spring-elastic manner.

3. The shading device as claimed in claim 2, wherein the traction mechanism drive comprises an elastic cord or at least one spring-elastic element.

4. The shading device as claimed in claim 1, wherein the traction mechanism drive extends between a driver, arranged in the region of at least one lateral guide rail, and a region of action rotationally fixed to the cover.

5. The shading device as claimed in claim 4, wherein the traction mechanism drive has a deflector which converts a direction of movement of the driver, when the extension profile is transferred from the rest position into the functional position, into a closing movement of the cover.

6. The shading device as claimed in claim 1, wherein the control mechanism comprises a control pushrod that acts on the cover, said control pushrod acting on the cover in opposite pulling and pushing directions, in order to transfer the cover into the closed position or the open position depending on the position of the extension profile.

7. The shading device as claimed in claim 10, wherein the closing moment, introduced into the cover, of the traction mechanism drive is greater than the opening moment of the control pushrod.
